(19) United States
(12) Patent Application Publication
(10) Pub. No.: US 2003/0104962 A1
(43) Pub. Date: Jun. 5, 2003

(54) Container and kit for laundering a fabric and a method therefor

(75) Inventors: Hedwige Clara Theophiel Verherbrugghen, Laarne-Kalken (BE); Graham John Boyd, Beijing (CN)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/309,602

(22) Filed: Dec. 4, 2002

Related U.S. Application Data
(60) Provisional application No. 60/337,811, filed on Dec. 5, 2001.

(51) Int. Cl. C11D 17/04

(52) U.S. Cl. 510/296

(57) ABSTRACT

A container for applying a detergent composition to a fabric has a hollow body member and a scrubbing surface. The hollow body member contains an interior surface and an exterior surface, while the scrubbing surface contains an aperture. A dispensing passage connects the interior surface and the aperture, while the exterior surface includes an ergonomic grip which has a wrist-palm rest. A kit for laundering a fabric contains the container and an instruction set, while a method of laundering a fabric employs the container which maintains the user's wrist at a use angle of from about 125° to about 220°.

### CROSS-REFERENCE TO RELATED APPLICATIONS

This application claims the benefit of priority to U.S. Provisional Application Serial No. 60/337,811, filed Dec. 5, 2001, which is herein incorporated by reference.

### FIELD OF THE INVENTION

The present invention relates to containers, kits and processes for laundering a fabric.

### BACKGROUND OF THE INVENTION

Laundering a fabric typically focuses on attempting to clean the fabric of undesirable dirt, spots, and stains. Containers, kits, and processes for laundering fabrics are typically divided between hand-washing and machine-washing. In a hand-washing context, various devices such as scrubbing brushes, pre-treaters, scrubbing and dispensing containers, and washboards are often used, either alone, or in conjunction with detergent formulations, long soaking times, and/or specialized stain-removers. While machine washing is less effort for the user, in the typical machine-washing context, there are times when relying upon a machine does not completely rid a fabric of the undesirable stain, spot, etc. Thus, even in the machine-washing context, special stain removing compositions, scrubbing implements, etc. may be used form time to time.

However, scrubbing a fabric and/or a stain on a fabric can be very tiring and require quite a bit of effort rubbing their hands and/or a scrubbing device back and forth over the fabric, or visa versa. This is especially true if many items are to be laundered, or a large area is to be cleaned. Furthermore, depending upon the customary cleaning method, including, for example, the relative position of the person cleaning the fabric, the washing location and height, the scrubbing device used, etc., a repetitive scrubbing process may cause in some people fatigue to the wrist, neck, and/or back. While such fatigue may be typically cured by rest and/or taking a break from such repetitive activity, it has now been recognized that it would be even more preferable to reduce the occurrence and severity of fatigue itself. Furthermore, it would also be useful to reduce the grip force needed to hold and use a scrubbing implement, pre-treatment implement and/or treatment implement.

It has also now been found that previous scrubbing devices are not comfortable for all hand sizes, in that smaller or larger hands may not easily hold and use a scrubber made for the average consumer's hand size. Thus, it is highly desirable to provide a single shape which is more comfortably held and used by a wider range of hand sizes, which allows dispensing with reduced wrist movements, and/or which provides better control.

Accordingly, the need exists for a container, and especially a treating and/or scrubbing device which reduces the effort needed and/or the fatigue accumulated during the fabric laundering process. The need also exists for a kit and a process which would reduce fatigue in the fabric laundering process.

### SUMMARY OF THE INVENTION

The present invention relates to an improved container for applying a detergent composition to a fabric which has a hollow body member and a scrubbing surface. The hollow body member has an interior surface and an exterior surface, while the scrubbing surface has an aperture. A dispensing passage connects the interior surface with the aperture, while the exterior surface includes an ergonomic grip which has a wrist-palm rest.

In a preferred embodiment, the present invention also relates to a kit for laundering a fabric. The kit contains a container and an instruction set. The container has a hollow body member and a scrubbing surface. The hollow body member has an interior surface and an exterior surface, while the scrubbing surface has an aperture. A dispensing passage connects the interior surface with the aperture, while the exterior surface includes an ergonomic grip which has a wrist-palm rest. The instruction set contains a first recommendation to premix a detergent composition and a solvent in the hollow body member, and a second recommendation to apply the premixed detergent composition and solvent to a fabric.

In another preferred embodiment, the present invention relates to a method of laundering a fabric including the steps of providing a container for applying a detergent, adding a detergent composition to the container, applying the detergent composition to the fabric and scrubbing at least a portion of the fabric with the container. The container has an ergonomic grip with a wrist-palm rest which maintains the user's wrist at a use angle of from about 125° to about 220°.

It has now been found that such a container provides an improved device, and especially an improved laundry scrubbing device which allows a user to launder a fabric with reduced effort and/or reduced fatigue during the scrubbing process. Furthermore, it has been found that the present invention is more comfortable to use, as the wrist-palm rest provides support which reduces wrist bending and strain and reduce the grip force required. Thus, the container may be used for a longer time, and/or for a larger surface while simultaneously reducing wrist strain and fatigue. It has also been found that the present invention may be comfortably used either while standing, sitting or crouching, and either with or without a wash basin, a washboard, an additional scrubbing surface, an automatic and/or semi-automatic washing machine, etc. In addition, it has been found that the present container is more comfortable to hold and use, regardless of hand size. In addition, the present container provides improved performance because of better ergonomic control of the device and may also save time during use, as there is no loss of time due to bending of the wrist. Time and fatigue is also reduced as dispensing does not necessitate a change in grip position. The present container may also provide improved control of the implement during scrubbing.

These and other features, aspects, advantages, and variations of the present invention, and the embodiments described herein, will become evident to those skilled in the art from a reading of the present disclosure and accompanying drawings, with the appended claims, and are covered within the scope of these claims.

### BRIEF DESCRIPTION OF THE FIGURES

While the specification concludes with claims particularly pointing out and distinctly claiming the invention, it is believed that the invention will be better understood from the following description of the accompanying figures in which like reference numerals identify like elements, and wherein:

FIG. 1 is a top perspective view of a preferred embodiment of the container of the present invention;

FIG. 2 is a cut-away view as seen along lines 2-2 of FIG. 1; and

FIG. 3 is a side view of a preferred embodiment of the present invention.

### DETAILED DESCRIPTION OF THE INVENTION

All percentages, ratios and proportions herein are by weight, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention. The figures herein are not necessarily drawn to scale.

As used herein, the term “comprising” means that other steps, ingredients, elements, etc. which do not affect the end result can be added. This term encompasses the terms “consisting or” and “consisting essentially of”.

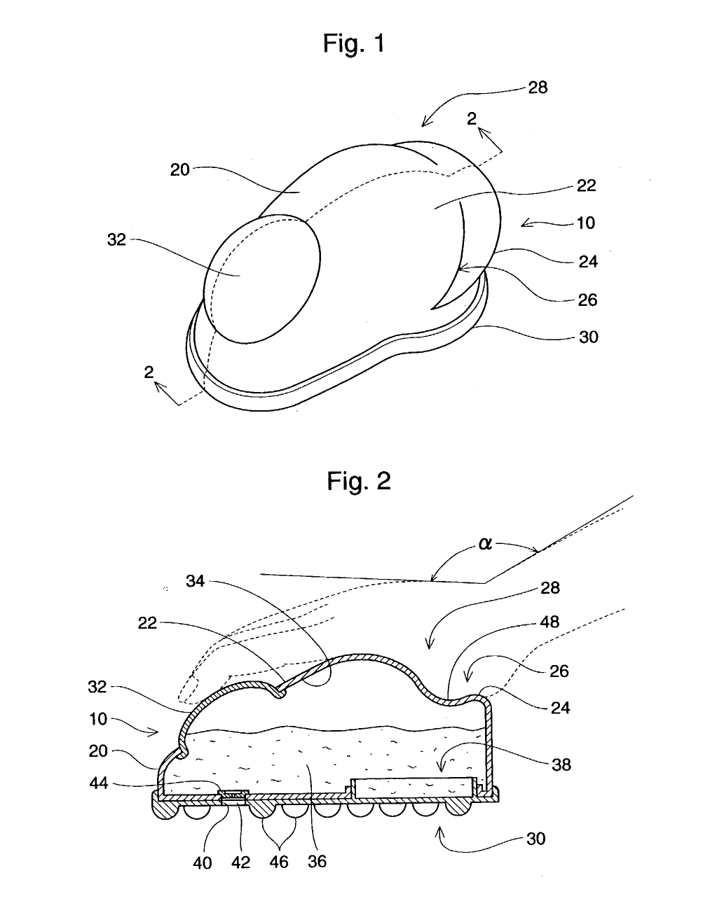

Referring to FIG. 1, a preferred embodiment of the present invention relates to a container, 10, which has a hollow body member, 20, which contains an interior surface (see FIG. 2 at 34) and an exterior surface, 22. During use, the hollow body member typically has an interior volume of from about 80 mL to about 1000 mL, preferably from about 100 mL to about 500 mL, and more preferably from about 150 mL to about 400 mL. Such an interior volume provides a balance between weight/size concerns and detergent composition concerns, and allows a typical laundry user to employ the container for hand scrubbing approximately 1 typical load of laundry items. Furthermore, it is recognized that often, the entire volume may not be filled with detergent composition and/or solvent—in many cases, a significant portion of the interior volume may contain air, suds, etc.

A wrist-palm rest, 24, is attached to the exterior surface, 22, at a connection region, 26, which has a concave surface (see FIG. 2 at 48). Without intending to be limited by theory, it is believed that the wrist-palm rest, 24, forms an ergonomic grip, 28, with the exterior surface, 22, which greatly increases the comfort and ease of use for the container, especially when it is used for a repetitive action such as scrubbing a fabric. In a preferred embodiment, the wrist-palm rest forms a convex section when cut perpendicular to line 2-2. Furthermore, it is believed that the ergonomic grip containing the wrist-palm rest significantly reduces the chance of fatigue and strain which may on occasion occur in some cases during, for example, extended scrubbing. It is also believed that an ergonomic grip containing the wrist-palm rest allows a user to apply pressure more easily and uniformly to the surface to be scrubbed, while reducing the angle at which the wrist is bent. This in turn leads to a surprisingly relaxed scrubbing style and position which is applicable to scrubbing in all positions, such as a standing position, a kneeling position, a sitting position, etc., and with all types of equipment such as a wash basin, a washboard/scrubbing board, a flat wash bench, etc.

The container should be formed in a variety of shapes and sizes that allow the container to be easily, comfortably, and conveniently held in the hand. Typically, the container, including the wrist-palm rest, will have a maximum length (as measured parallel to the scrubbing surface) of from about 6 cm to about 25 cm, preferably from about 7 cm to about 20 cm, and more preferably from about 10 cm to about 15 cm. The container typically has a maximum width (as measured parallel to the scrubbing surface, and perpendicular to the length) of from about 3 cm to about 15 cm, preferably from about 4 cm to about 10 cm, and more preferably from about 5 cm to about 8 cm. However, it is recognized that in many cases, the actual length, width and/or height of the container may vary as portions thereof are contoured to further enhance the ergonomics and comfort of the container. For example, a large scrubbing area may be attached to a handle, where the handle has the dimensions described above. Alternatively, the container shape may be tapered, or remain the same length, height and/or width throughout.

Preferably, the housing is shaped in an easy-to-form shape that reduces container fabrication costs. Such easy-to-form shapes include those having a generally circular cross-section (such as cylindrical shapes), a square or rectangular cross-section, an oval cross-section, and combinations thereof, and more preferably those having a circular cross-section or a flattened oval cross-section. Without intending to be limited by theory, it is believed that a cylindrical-shaped container having a circular cross-section with thin walls is especially preferred as it is easy and inexpensive to fabricate, has good structural stability while also reducing materials costs, provides good resiliency and is optionally squeezable.

Preferred container materials include plastics and polymers, flexible materials such as films and laminated papers, rubber, glass, metal, and combinations thereof. More preferred container materials include rubber, plastic, polyesters, and combinations thereof, and even more preferred container materials include polyethylene, polypropylene, polyethylene terephthalate, thermoplastic elastomer, and combinations thereof. Flexible container parts preferably contain at least a portion of thermoplastic elastomer. Preferred production processes are blow molding, injection molding, injection blow molding, vacuum forming, thermoforming, and combinations thereof. The various individual container portions may be formed with different materials, and/or by different processes, as desired. Optional, but preferred characteristics of the container material include color, tinting, translucency, transparency, or opaqueness. Other characteristics include easy formation to the desired shape(s), resistance to detergent solutions and applicable pH ranges, durability, coloration, coatings and/or softness to allow the container to be added to the wash cycle without causing undue noise. It is highly preferred that the container material be transparent or translucent, to allow the user to visibly gauge the level of detergent composition and/or solvent contained therein. If the container (or a part thereof) is to be placed inside a machine wash cycle, then the container material should be temperature resistant to machine-washing temperatures, i.e., typically from about 5° C. to about 90° C. Ideally; the container material selected should be resistant to temperatures ranging from below freezing up to above the temperatures at which clothes dryers operate. These optimal ranges may be relevant, for example, where consumers store cleaning supplies outside during the winter, and where the container may be transferred, either intentionally or unintentionally, into a clothes dryer.

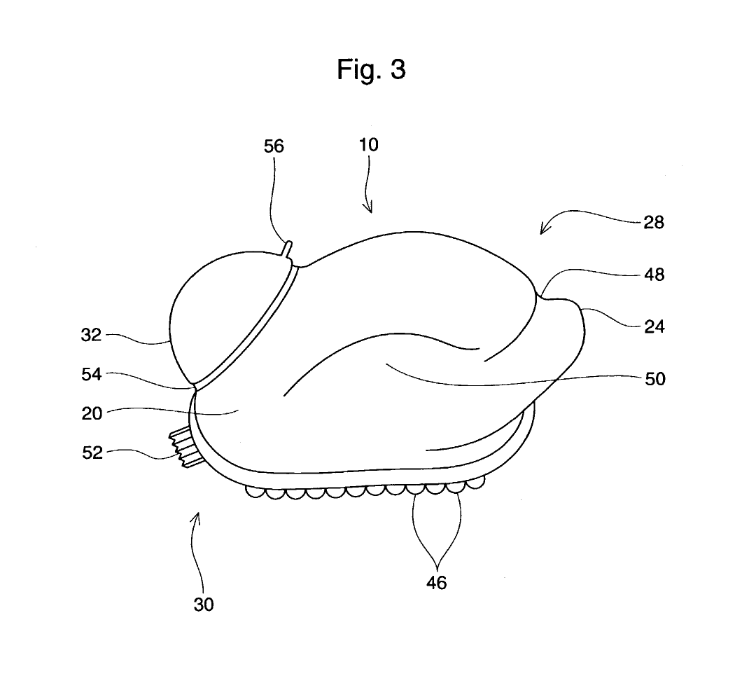

The hollow body member, 22, also contains a scrubbing surface, 30, which contacts and is intended to be rubbed against the surface to be cleaned, i.e., a fabric, during use to help clean the item and remove embedded dirt, oils, etc. The scrubbing surface useful herein is preferably formed of a sponge, a brush (see FIG. 3 at 52), a woven material, a nonwoven material, an abrasive material, a plastic material, a cloth material, a polymeric material, a resin material, a foam rubber material, a functional absorbent material (FAM), a polyurethane foam, a rubber material, or a mixture thereof, preferably a brush (see FIG. 3 at 52), an abrasive material, a regular or intermittent series of protrusions (see FIG. 2 at 46) and a mixture thereof. The scrubbing surface may be formed of the same material as the hollow body member, or may be formed of a different material, as is preferred. If the scrubbing surface is formed from a relatively delicate material, or a material that is easily torn, then it is preferable that this material be covered, partially or completely, with a water-permeable, more robust material, such as a nonwoven material. Preferably, the FAM useful herein has an absorbent ability of more than about 20 g H₂O/g, more preferably, 40 g H₂O/g by weight of FAM. Such a preferred FAM is described in U.S. Pat. No. 5,260,345 to DesMarais, et al., issued on Nov. 9, 1993 or U.S. Pat. No. 5,889,893 to Dyer, et al., issued on May 4, 1999.

To reduce the perceived potential for fabric damage, the scrubbing surface preferably does not contain sharp and/or hard protrusions, but instead is substantially formed of rounded and/or resilient protrusions. Furthermore, the scrubbing surface may contain a variety of different protrusions to allow, for example, both normal scrubbing with the majority of the scrubbing surface, and intensive scrubbing of difficult stains with a smaller section of the scrubbing surface. Such optional varied protrusions also allow the user to vary the amount of contact, pressure, etc., between the scrubbing surface and different types of items to be cleaned, for example, cotton fabric and silk, which have different sensitivities to abrasion. The scrubbing surface may also be a porous scrubbing surface with an open-celled structure to enhance cleaning and the passage of water and cleaning composition through the scrubbing surface. Such a porous scrubbing surface may also promote desirable lathering characteristics when used with a detergent composition.

The scrubbing surface may be permanently affixed to the waterproof casing and/or joined to the exterior area. However, in many cases, it is desirable to provide a detachable scrubbing surface that may be easily removed, replaced, and/or exchanged. For example, a plurality of scrubbing surfaces may be provided, each of which has particular cleaning characteristics, such as a predetermined resiliency, a special shape, a special cleaning chemistry, may be designed for a specific type of fabric (i.e., cotton, nylon, silk, wool, etc.), etc. The detachable scrubbing surface useful herein may be shaped in virtually any shape, as desired, but preferably has a substantially flat base with a plurality of similar protrusions. In addition, the hardness/softness and texture of the scrubbing surface and/or protrusions may also be varied. Such varied scrubbing surfaces may even be combined on the same exterior surface. Each of these scrubbing surfaces may be detachably fixed to the hollow body member, and exchanged as appropriate. In addition, a detachable scrubbing surface has the advantages of being easily replaced when worn out, for cleaning and sanitation purposes, etc.

In FIG. 1, the exterior surface, 22, also contains a pump, 32, which is depressed to draw in and/or expel solvent, premixed detergent composition and solvent, etc., via the aperture (see FIG. 2 at 42). For ease of use, the pump, 32, is positioned to be actuated with the same hand as is holding the container, 10; preferably the pump, 22, is located in a position to be depressed by one or more fingers, as shown in FIGS. 1 and 2. Alternatively, the pump may be positions so as to be actuated by the user's thumb, by squeezing the exterior surface or a specific portion thereof with the fingers, or by pressure on the wrist-palm rest, etc., as desired. It is preferred that the pump is located distal to the wrist-palm rest, so that force may be easily applied for scrubbing, without inadvertently actuating the pump. The pump is typically actuated by being physically depressed to increase the pressure within the interior, and cause the premixed detergent composition and solvent to exit the aperture. When the hollow body member is empty, and when it is fully actuated or fully depressed, the pump typically displaces from about 10 mL to about 200 mL, preferably from about 15 mL to about 150 mL, and more preferably from about 25 mL to about 100 mL of air. The pump is typically made of a flexible and resilient material, such as rubber, plastic, thermoplastic elastomer, a thin film, silicone and a mixture thereof, preferably rubber, thermoplastic elastomer, silicone and a mixture thereof. These materials are preferred, as they are usually cheap and easy to form, resilient to typical washing conditions, and yet are sturdy enough for repeated use. In an alternate embodiment, the flexibility of the pump is a product of the geometrical design and/or variations in wall thickness and not a product of the choice of material per se; for example, bellows-type pumps, piston-type pumps, etc. are also useful herein.

Preferably, the pump is actuated by a pressure of from about 30 kPa to about 100 kPa, preferably from about 40 kPa to about 80 kPa and more preferably by a pressure of from about 45 kPa to about 55 kPa. It is believed that this allows actuation by application of a force using a typical finger(s), so that the contents are dispensed only when so desired by the user.

FIG. 2, is a cut-away view as seen along lines 2-2 of FIG. 1, and shows a container, 10, having a hollow body member, 20, with an exterior surface, 22, and an interior surface, 34. In this preferred embodiment, the pump, 32, is connected to the interior surface, 34, so as to form a preferred substantially water-tight seal. The seal may optionally be air-tight as well. While the container is typically substantially water-tight when properly assembled, a slight air leakage in the pump seal and/or another seal may be useful in certain embodiments, so as to allow the pump to re-prime more quickly. Such a water-tight and/or air-tight seal can be formed via methods known in the art, such as employing adhesives, heat-sealing, gaskets, bi-injection molding, etc. Alternatively, the pump may also be integral with a portion of the hollow body member, especially the exterior surface, rather than a separately formed piece.

In this preferred embodiment the scrubbing surface, 30, is optionally formed from a separate piece from the hollow body member, 20. The scrubbing surface, 30, is designed to be removable so as to facilitate filling of the hollow body member, 20, with a detergent composition and/or a solvent, to form a premixed detergent composition and solvent, 36, via a resealable filling orifice, 38. The resealable filling orifice, 38, is sealed by snapping the hollow body member, 20, and the scrubbing surface, 30, together. Alternatively, the hollow body member may be resealably attached by a mated threaded screw, a clip, a hinge, combinations thereof, and/or other attachment devices known in the art. Additional seals and closures useful between 35 any two or more parts of the container described herein are described as “Closures, Bottle and Jar,” in “The Wiley Encyclopedia of Packaging Technology,” A. L. Brody and K. S. Marsh, editors, pp. 206-20, (John Wiley & Sons, New York, 2^{nd} Ed. 1997).

In FIG. 2, the scrubbing surface, 30, and the interior surface, 34, further define a dispensing passage, 40, which allows passage of materials from the interior of the hollow body member, 20, to the exterior thereof, and visa versa. The dispensing passage, 40, terminates in an aperture, 42, through which materials may pass. The number of dispensing passages and corresponding apertures is highly variable, but is typically from about 1 to about 10, preferably from about 1 to about 5, and more preferably from about 1 to about 3 dispensing passages and corresponding apertures. Without intending to be limited by theory, it is believed that a lower number of dispensing passages allows the user to more easily control the amount of materials dispensed and/or drawn into the hollow body member, via the dispensing passage. Each dispensing passage and/or aperture may be of any shape, preferably round, oval, square, or rectangular, and may be from about 0.0019 mm² to about 16 mm², preferably from about 0.2 mm² to about 5 mm², and more preferably from about 0.3 mm² to about 3.2 mm² in cross-sectional area. Preferably at least one dispensing passage and aperture are positioned towards the “front” of the container below where the fingers are located during use. Without intending to be limited by theory, it is believed that such an arrangement leads to more intuitive dispensing and scrubbing, as users typically expect the premixed detergent composition and solvent to be dispensed from near the location of the user's fingers.

In FIG. 2, the resealable filling orifice, 38, is distinct from the aperture, 42, and the dispensing passage, 40. This highly preferred design allows the container, 10, to possess a large resealable filling orifice, 38, which can accommodate a scoop or relatively large measuring device with which the detergent composition may be added to the interior of the hollow body member, 20. However, when dispensing and scrubbing, a small dispensing passage is preferred, as this allows more accurate amounts of premixed detergent composition and solvent to be expelled from the container. Thus, such a preferred arrangement significantly reduces messiness during filling, use, and cleaning of the container. In an alternate embodiment (not shown), the resealable filling orifice may contain and/or be integral with the dispensing passage and/or the aperture. Typically, the resealable filling orifice is approximately circular, oval, square, or rectangular, preferably circular, in shape and will measure from about 25 mm to about 120 mm, preferably from about 30 mm to about 105 mm, and more preferably from about 35 mm to about 85 mm in width, as measured at the widest point thereof. As this size accommodates most granular detergent compositions' scoops, this size is especially useful if a granular detergent composition is intended to be added to the interior of the hollow body member.

In FIG. 2, an optional valve, 44, is attached to the interior surface, 34. The valve, 44, helps the user to easily regulate the flow of materials (i.e., a detergent solution/mixture), water and/or air into and/or out of the hollow body member, 20, and reduces, and preferably prevents, dripping from the interior volume defined by the interior surface, 34, of the hollow body member, 20, unless the pump, 32, is activated. Thus, during use of the container, 10, herein, any materials passing from the interior surface, 34, to the scrubbing surface, 30, first pass through the valve, 44. Such a valve is typically a pressure-activated two-way valve which is formed of a thin or film-like flexible, stretchable and/or expandable material such as plastic, silicone, rubber, thermoplastic elastomer and a mixture thereof which quickly, easily and repeatably returns to its original shape and/or size in the absence of a pressure differential. Preferred valves herein include two-way valves formed of silicone or thermoplastic elastomer having at least one slit therein to let materials through to relieve a pressure differential. One-way valves are also useful herein, either for separately dispensing or for drawing in solvent and/or air into the hollow body member. If a one-way valve is employed in the container herein, then typically at least two such valves will be present. While other more complicated valves may be employed in the present invention, they may be too expensive for the typical container.

The scrubbing surface, 30, also contains a plurality of protrusions, 46, which are rounded to minimize the potential for fabric damage and yet to still effectively distribute the detergent composition and solvent into the fabric to help clean it. Such protrusions may also help to work the detergent composition into the fabric, to loosen encrusted dirt from the fabric, to penetrate and work loose oils and stains, etc. The protrusions useful herein may be arranged in a regular pattern or a random pattern, and may be made of combinations of different sizes, shapes, and textures of protrusions. Typically, in order to reduce possible damage to the surface to be cleaned, especially fine fabrics such as silk, sharp protrusions should be avoided unless they are formed of a soft, flexible, and/or bendable material. In a preferred embodiment, rounded protrusions are employed herein having a dome-like and/or hemispherical shape, and a diameter of from about 1 to about 15 mm, preferably from about 2 mm to about 12 mm. In another preferred embodiment, smaller rounded protrusions having a diameter of from about 2 mm to about 6 mm are arranged on the scrubbing surface near the aperture, while larger rounded protrusions having a diameter of from about 8 mm to about 12 mm are arranged on the scrubbing surface distal from the aperture. It is preferred that the protrusions are arranged to substantially cover the surface of the scrubbing surface, so as to maximize the cleaning performance of the container during use. It is also preferred that at least one protrusion and aperture be arranged substantially adjacent to each other, such that when the premixed detergent and solvent is expelled from the aperture, it contacts a protrusion. The scrubbing surface is preferably designed to wear out in a manner which minimizes performance loss and/or fabric damage, by, for example, rounding the base of the scrubbing surface upon which the protrusions are affixed, by selecting the scrubbing surface material to wear without forming sharp slivers and/or edges which can catch and tear fabrics, etc. Thus, in a highly preferred embodiment, the base of the scrubbing surface has an overall slightly convex shape with a center which preferably rises from about 0.2 mm to about 8 mm, more preferably from about 0.5 mm to about 5 mm higher than the edge. Such a center rise in the base of the scrubbing surface may be measured either laterally and/or transversely, and preferably both laterally and transversely. Without intending to be limited by theory, it is believed that such a slightly convex shape allows the user to employ a pressure gradient during treating and/or scrubbing which more evenly distributes the force against the fabric. This reduces bunching up of the fabric in front of the implement, and stretching of the fabric behind the implement to significantly reduce stretching and disfiguring of the fabric and/or garment.

In FIG. 2, the details of a preferred ergonomic grip, 28, can be seen. In this embodiment, the wrist-palm rest, 24, is attached to the hollow body member, 20, in a connection region, 26. The connection region, 26, contains a concave surface, 48, as viewed from the exterior surface, 22. Without intending to be limited by theory, it is believed that the concave surface, 48, provides the ergonomic grip, 28, with a comfortable area which reduces wrist strain and substantially maintains the user's wrist at a use angle, α, of from about 125° to about 220°, preferably from about 140° to about 210°, and more preferably from about 155° to about 195°, as measured by the intersection between the planes formed by the back of the wrist and the dorsal forearm during scrubbing therewith. Such an ergonomic grip, 28, which maintains a user's wrist at the use angle, α, has been found to be remarkably comfortable in a variety of scrubbing positions, even with continued, vigorous scrubbing.

FIG. 3 shows a side view of a preferred embodiment of the present invention, where the side of the hollow body member, 20, contains an indented finger grip, 50. Such an indented finger grip is preferred for a container made for scrubbing, because it allows the user to more securely hold and use the container, even under wet and slippery conditions. Alternatively, the hollow body member may contain an integral or removable rubber grip (not shown) which enhances and maintains the user's grip on the container during use. The wrist-palm rest, 24, and the exterior surface, 22, form a concave surface, 48, which further enhances the user's grip on the container, 10, during use, and maintain the user's wrist at the proper use angle.

The scrubbing surface, 30, is formed from both protrusions, 46, and a brush, 52, for cleaning different areas, fabrics, and stains. For fabrics, preferred brushes have a bristle strength of less than about 200 N/cm², preferably less than about 150 N/cm². Bristle strength, as noted herein, is measured using the method of JIS S 3016, except that a press head speed of 12.5 mm/min, and a bristle area of about 5.5 cm² were used; JIS S 3016 is a Japanese Industrial Standard for measuring toothbrush bristle strength. The compression testing machine used herein is a Compression Tester, model YLM-5, made by Toyo Tester, of Osaka, Japan. Furthermore, the pump, 32, is removably connected to a collar, 54, on the hollow body member, 20. The hemispherical rubber pump, 32 snaps onto and forms an air-tight seal with the collar, 54, which is made of a hard plastic ring. The rubber pump, 32, is easily removable from the collar, 54, by gripping and pulling on tab, 56, to reveal a resealable filling orifice (hidden in FIG. 3). As the pump, 32, is removable so as to allow easy filling of the hollow body member, 20, with a detergent composition, the scrubbing surface, 30, is integral with and permanently affixed to the hollow body member, 20. Alternatively, a pump may be also be formed in other ways, such as being permanently attached to a female screw-cap which affixes to a corresponding male-threaded protrusion which forms the resealable filling orifice.

If the container is at any location clear, translucent or transparent, then a highly preferred optional feature is at least one level indicator, preferably more than two level indicators, which serve to inform the user as to how much detergent, and/or solvent should be added to, or is currently contained within the container. In a preferred embodiment, the level indicator is molded onto the container during the production process. In a preferred embodiment, the container herein has a set of level indicators for treating normally soiled fabrics and a separate set of level indicators for treating heavily soiled fabrics. The level indicators may serve as a set of usage instructions for using the container, and/or the detergent composition and solvent in combination. Accordingly, a highly preferred embodiment of the container herein contains usage instructions, either actually on the container, or otherwise provided with the container, e.g., as part of a kit. Preferably, the level indicator(s), usage instructions, etc. are directly printed, silk-screened, etched, molded into the container, or otherwise attached to the container, via, for example, a sticker, or label.

The container herein may be used and/or sold alone, or with other scrubbing, pre-treating and/or cleaning implements, such as, for example, a wash basin, a wash board, a scrubbing surface, a brush, etc. The container herein is also typically sold with a detergent composition, and/or is sold with an instruction set which recommends that the container be used with a detergent composition. Detergent compositions useful herein include solid and liquid detergent compositions known in the art, such as powders, granules, tablets, liquids, gels, pastes, emulsions, and combinations thereof. The detergent composition useful herein typically contains one or more ingredients selected from the group consisting of a detersive surfactant, a bleach, a bleach activator, a builder, an optical brightener, an enzyme, a fabric softener, and mixtures thereof; preferably an anionic surfactant, an oxygen bleach, a bleach activator, a builder, an enzyme, a fabric softener, and mixtures thereof.

The detergent composition herein typically comprises, by weight of the detergent composition, at least about 0.01%; more preferably at least about 0.1%; even more preferably from about 1% to about 55%; and even more preferably still from about 1% to about 35% of a detersive surfactant. The detersive surfactant may be selected from an anionic surfactant, a cationic surfactant, a nonionic surfactant, a zwitterionic surfactant, and a mixture thereof; preferably from an anionic surfactant, and a mixture thereof. Particularly useful anionic surfactants include the C₁₀-C₂₀ branched and linear alkyl benzene sulfonate surfactants, and the C₁₀-C₂₀alkyl sulfate surfactants.

The detergent composition herein preferably contains a bleach at a level of from about 0.5% to about 30%, preferably from about 1.5% to about 20% by weight of the detergent composition. A preferred bleach includes an oxygen bleach, a chlorine bleach, a photobleach, an enzymatic bleach, and a mixture thereof, and more preferably an oxygen bleach, and a mixture thereof. A highly preferred oxygen bleach includes hydrogen peroxide, percarbonate, perborate, per-acids, per-oxides, and mixtures thereof. If present, the amount of bleach activator will typically be from about 0.1% to about 60%, preferably from about 0.5% to about 40% by weight of the detergent composition. A preferred bleach activator includes a transition metal bleach catalyst, a hydrophilic bleach activator, a hydrophobic bleach activator, and a mixture thereof, more preferably a manganese bleach catalyst, N,N,N′N′-tetraacetyl ethylene diamine (TAED), nonanoyloxybenzene sulfonate (NOBS), 6-nonylamino-6-oxoperoxycaproic acid (NAPAA), and mixtures thereof. Additional bleaches and bleach activators are disclosed in U.S. Pat. No. 4,483,781 to Hartman, issued Nov. 20, 1984; U.S. patent application Ser. No. 740,446 to Bums et al., filed Jun. 3, 1985; European Patent Application 0,133,354 to Banks et al., published Feb. 20, 1985; U.S. Pat. No. 4,412,934 to Chung and Spadini, issued Nov. 1, 1983; U.S. Pat. No. 4,634,551 to Hardy and Ingram, issued Jan. 6, 1987; U.S. Pat. No. 5,061,807 to Gethoffer, et al., issued Oct. 29, 1991; U.S. Pat. No. 5,246,621 to Favte, et al., issued Sep. 21, 1993; and Japanese Laid-Open Patent Application (Kokai) No. 4-28799 to Yamada, et al., published Jan. 31, 1992.

A builder may be included in the detergent composition herein to assist in controlling mineral hardness, and to assist in the removal of particulate soils. When present, the detergent composition will typically comprise at least about 1% builder. Liquid detergent compositions typically comprise from about 5% to about 50%, more typically about 5% to about 30%, by weight, of a builder. Granular detergent compositions typically comprise from about 10% to about 80%, more typically from about 15% to about 50% by weight, of a builder. Lower or higher levels of builder, however, are not meant to be excluded. A phosphate builder, a silicate builder, a zeolite builder, a carboxylate builder, a carbonate builder, a citrate builder, a polycarboxylate builder, and a mixtures thereof is useful herein; preferably the builder is selected from Zeolite A, Zeolite P (B), Zeolite MAP, Zeolite X, layered silicate builders, carbonate, and mixtures thereof. Useful builders are also described in U.S. Pat. No. 4,664,839, issued May 12, 1987 to Rieck; German Patent Application No. 2,321,001 to Jacobsen, et al., published Nov. 15, 1973; U.S. Pat. No. 4,566,984 to Bush, issued Jan. 28, 1986; U.S. Pat. No. 4,144,226 to Crutchfield, et al., issued Mar. 13, 1979; and in U.S. Pat. No. 3,308,067 to Diehl, issued Mar. 7, 1967.

Any optical brighteners or other brightening or whitening agents known in the art may be incorporated at levels typically from about 0.05% to about 1.2%, by weight, into the detergent composition. Specific examples of optical brighteners which are useful in the present compositions are those identified in U.S. Pat. No. 4,790,856, issued to Wixon on Dec. 13, 1988. These brighteners include the PHORWHITE series of brighteners from Verona. Other brighteners disclosed in this reference include: Tinopal UNPA, Tinopal CBS and Tinopal 5BM; available from Ciba-Geigy; Artic White CC and Artic White CWD, available from Hilton-Davis, located in Italy; the 2-(4-stryl-phenyl)-2H-napthol[1,2-d]triazoles; 4,4-bis-(1,2,3-triazol-2-yl)-stilbenes; 4,4′-bis(stryl)bisphenyls; and the aminocoumarins. Specific examples of these brighteners include 4-methyl-7-diethyl-amino coumarin; 1,2-bis(-venzimidazol-2-yl)ethylene; 1,3-diphenyl-phrazolines; 2,5-bis(benzoxazol-2-yl)thiophene; 2-stryl-napth-[1,2-d]oxazole; and 2-(stilbene-4-yl)-2H-naphtho-[1,2-d]triazole. See also U.S. Pat. No. 3,646,015, issued Feb. 29, 1972 to Hamilton. Anionic brighteners are preferred herein.

An enzyme may also be useful herein for a variety of purposes, including removal of protein-based, carbohydrate-based, or triglyceride-based stains from substrates, for the prevention of refugee dye transfer in fabric laundering, and for fabric restoration. A suitable enzyme herein includes an amylase, a cellulase, a cutinase, a lipase, a peroxidase, a protease, and mixtures thereof of any suitable origin, such as vegetable, animal, bacterial, fungal and yeast origin. In practical terms, the detergent composition will typically comprise, by weight, from about 0.001% to about 5%, preferably from about 0.01% to about 1% of a commercial enzyme preparation.

An amylase useful herein includes, for example, -amylases described in GB 1,296,839 to Outtrup H, et al., published Nov. 22, 1972 to Novo Industries A/S of Denmark (hereinafter, “Novo”); RAPIDASE® from International Bio-Synthetics, Inc.; TERMAMYL® from Novo; NATALASE® from Novo; and FUNGAMYL® from Novo.

Cellulases usable herein include both bacterial and fungal types, preferably having a pH optimum between 5 and 9.5. U.S. Pat. No. 4,435,307 to Barbesgoard, et al., Mar. 6, 1984, discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-B-2,075,028 to Barbesgaar, et al., issued Mar. 28, 1984; GB-B-2,095,275 to Murata, et al., issued Aug. 7, 1985 and DE-OS-2,247,832 to Horikoshi and Ikeda, issued Jun. 27 1974. CAREZYME® and CELLUZYME® from Novo are especially useful. See also WO 91/17243 to Hagen, et al., published Nov. 14, 1991.

Cutinase enzymes suitable for use herein are described in WO 88/09367A to Kolattukudy, et al., published Dec. 1, 1988.

Suitable lipase enzymes for detergent usage include those produced by microorganisms of the Pseudomonas group, such as Pseudomonas stutzeri ATCC 19.154, as disclosed in GB 1,372,034 to Dijk and Berg, published Oct. 30, 1974. See also lipases in Japanese Patent Application 53-20487 to Inugai, published Feb. 24, 1978. This lipase is available from Amano Pharmaceutical Co., Ltd. of Nagoya, Japan, under the trade name Lipase P “Amano,” or “Amano-P.” Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., the Netherlands, and lipases ex Pseudomonas gladioli. LIPOLASE® from Novo is a preferred lipase for use herein. LIPOLASE® is derived from Humicola lanuginosa, see also EP 341,947 to Comelissen, et al., issued Aug. 31, 1994. Lipase and amylase variants stabilized against peroxidase enzymes are described in WO 94/14951 to Halkier, et al., published Jul. 7, 1994 A to Novo. See also WO 92/05249 to Clausen, et al., published Apr. 2, 1992.

Peroxidase enzymes may be used in combination with oxygen sources, e.g., percarbonate, perborate, hydrogen peroxide, etc., for “solution bleaching” or prevention of transfer of dyes or pigments removed from substrates during the wash to other substrates present in the wash solution. Known peroxidases include horseradish peroxidase, ligninase, and haloperoxidases such as chloro- or bromo-peroxidase. Peroxidase-containing detergent compositions are disclosed in WO 89/09813 A to Damhus, et al., published Oct. 19, 1989.

A suitable example of a protease is a subtilisin, which is obtained from particular strains of B. subtilis and B. licheniformis. One suitable protease is obtained from a strain of Bacillus, having maximum activity throughout the pH range of 8-12, developed and sold as ESPERASE® by Novo. Other examples of a suitable protease includes ALCALASE® and SAVINASE® from Novo and MAXATASE® from International Bio-Synthetics, Inc., the Netherlands; as well as Protease A and Protease B as disclosed in EP 130,756 A to Bott, published Jan. 9, 1985. An especially preferred protease, referred to as “Protease D,” as described in U.S. Pat. No. 5,679,630 to A. Baeck, et al, issued Oct. 21, 1997, entitled “Protease-Containing Cleaning Compositions,” and U.S. Pat. No. 5,677,272 to C. Ghosh, et al, issued Oct. 14, 1997, entitled “Bleaching Compositions Comprising Protease Enzymes.”

Commercially-available enzymes are typically available as an enzyme prill, an enzyme marume, a high-shear granule, or even an already-coated granule. Any of these enzyme forms may be coated by the improved encapsulation coating described herein. For example, a preferred embodiment comprises an enzyme prill which contains an enzyme. Preferred examples of commercially-available enzymes useful herein include SAVINASE®, sold by Novo Corporation, Maxacal sold by Gist-brocades, Opticlean sold by Solvay-Interox, Co, and Enzoguard sold by Genencor.

The detergent composition may optionally contain a fabric softener therein, preferably a fabric softening clay, a secondary fabric softener component, and a mixture thereof. The fabric softening clay is preferably a smectite-type clay. Preferably the clay particles are of a size that they can not be perceived tactilely, so as not to have a gritty feel on the treated fabric of the clothes. The fabric softening clay may be added at levels of from about 1% to about 50%, preferably from about 2% to about 20%, and more preferably about 3% to 14%.

A secondary fabric softener component in addition to the fabric softening clay may be present at levels of about 0.1% to 5%, more preferably from 0.3% to 3%, and include: amines of the formula R₄R₅R₆N, wherein R₄ is C₅ to C₂₂hydrocarbyl, R₅ and R₆ are independently C₁ to C₁₀hydrocarbyl. One preferred amine is ditallowmethyl amine; complexes of such amines with fatty acid of the formula R₇COOH, wherein R₇ is C₉ to C₂₂hydrocarbyl, as disclosed in EP Pub. No. 0 133 804; complexes of such amines with phosphate esters of the formula R₈O—P(O)(OH)—OR₉ and HO—P(O)(OH)—OR₉, wherein R₈ and R₉ are independently C₁ to C₂₀alkyl of alkyl ethoxylate of the formula -alkyl-(OCH₂CH₂); cyclic amines such as imidazolines of the general formula 1-(higher alkyl)amido(lower alkyl)-2-(higher alkyl)imidazoline, where higher alkyl is from 12 to 22 carbons and lower alkyl is from 1 to 4 carbons, such as described in UK Patent Application GB 2,173,827; and quaternary ammonium compounds of the formula R₁₀R₁₁R₁₂R₁₃N⁺X⁻, wherein R₁₀ is alkyl having 8 to 20 carbons, R₁₁ is alkyl having 1 to 10 carbons, R₁₂ and R₁₃ are alkyl having 1 to 4 carbons, preferably methyl, and X is an anion, preferably Cl⁻ or Br⁻, such as C₁₂₋₁₃alkyl trimethyl ammonium chloride. Clay softeners in combination with amine and cationic softeners are disclosed, for example, in U.S. Pat. No. 4,375,416 to Crisp et al., Mar. 1, 1983 and U.S. Pat. No. 4,291,071 to Harris et al., issued Sep. 22, 1981.

Other adjunct materials useful in the detergent composition herein includes other active ingredients such as carriers, processing aids, suds suppressers, suds boosters, dyes, pigments, perfumes, perfume derivatives, dye transfer inhibitors, clay soil removal agents, dispersants, alkalinity sources and pH buffers, soil suspension polymers, anti-redeposition polymers, etc. Additional detergent formulations useful herein are described in WO 91/08281 to Foster and Vandepas, published Jun. 13, 1991; U.S. Pat. No. 5,487,818 to Cavaillotti, et al., issued Jan. 30,1996; U.S. Pat. No. 5,470,988 to Jaekel, issued Nov. 28, 1995; and U.S. Pat. No. 5,466,825 to Carr, et al., issued Nov. 14, 1995.

The typical solvent useful herein to premix, and preferably predissolve the detergent composition is water, such as tap water, wash water, or water from other sources. However, other solvents may also be useful herein, as desired, such as an alcohol, an organic solvent, and mixtures thereof, either alone or in combination with water.

Preferably, the premixed detergent composition and solvent form a premix (i.e., a fluid, dispersion, mixture, or suspension) having a viscosity of less than about 500 centipoise (cP), preferably from about 1 to about 500 cP, and more preferably from about 10 to about 250 cP, as measured at 21° C., by a Brookfield Viscometer at a shear rate of 1.0 rpm. Centipoise is the cgs-metric system unit of viscosity and has the dimensions of dyne-seconds per square centimeter or grams per centimeter-second. Preferably, the valve, dispensing passage and/or aperture are coordinated to the premix's viscosity such that when no manual pressure is exerted on the container or the pump, and the container is oriented for use, the fluid flow rate through the dispensing passage from about 0 mL/min to about 300 mL/min, preferably from about 0 mL/min to less than about 100 mL/min, and more preferably from about 0 mL/min to less than about 25 mL/min. However, if the container and/or hollow body member is formed of a resilient material, manual pressure exerted upon the container and/or hollow body member may cause the flow rate to increase beyond 300 mL/min. In addition, actuation of the pump may also cause the flow rate to increase beyond the ranges stated above.

Instruction Set

The container herein typically contains, is sold with, or has attached thereto an instruction set which contains recommendations for how to use the container. The instruction set usually contains a first recommendation to premix the detergent composition and a solvent in the hollow body member, and a second recommendation to apply the premixed detergent composition and solvent to a fabric, typically by pressing the pump so as to dispense a limited quantity of the premix contained within the hollow body member. More typically, the instruction set will further contain a third recommendation to treat and preferably scrub, at least a portion of the fabric with the container's scrubbing surface. Other optional, but preferred recommendations for the instruction set include:

a recommendation for the user to maintain the wrist in a wrist angle as described herein;

a recommendation to, in order, add the detergent composition into the hollow body member, to seal the hollow body member, to immerse at least the aperture into the solvent, and then to repeatedly actuate the pump to draw solvent into the hollow body member and thereby form the premix;

a recommendation to shake the container once the detergent composition and solvent are added, so as to form the premix;

a recommendation to employ the container as a treater or pre-treater in a washing process, preferably for removing spots and stains in a machine washing process;

a recommendation to employ the container as a scrubber for entire fabrics in a hand washing process;

a recommendation to empty any remaining premix into the wash when scrubbing is complete; and/or

a recommendation to at least partially disassemble the container and add it to a washing machine.

Examples of the invention are set forth hereinafter by way of illustration and are not intended to be in any way limiting of the invention. The examples are not to be construed as limitations of the present invention since many variations thereof are possible without departing from its spirit and scope.

### EXAMPLE 1

A container according to FIG. 1 and FIG. 2 is prepared by injection molding transparent polypropylene into a hollow body member having an average thickness between the exterior surface and the interior surface of 0.8 mm. The hollow body member is only slightly resilient, and contains one horizontal level indicator. The scrubbing surface is separately formed of opaque polypropylene and has hemispherical protrusions with a diameter of 5 mm which substantially cover the entire scrubbing surface, except at the aperture. A water-proof valve of flexible silicone rubber is attached to the interior surface where the single dispensing passage begins, and prevents premixed detergent composition and water from exiting the valve, unless the pump is depressed. The pump displaces about 45 mL of air when fully depressed, which is sufficient to cause the valve to transiently open, equalize the pressure differential, and then close. The resealable filling orifice is a round opening 45 mm in diameter, which contains a edge which snaps together with the scrubbing surface to form a water-tight seal. The wrist-palm rest maintains the user's wrist at a use angle of 170°.

The container is sold together with a 1.5 kg box of an oxygen bleach-containing granular laundry detergent, and is also separately shrinkwrapped with granular powder sachets. Both versions are sold with an instruction set with the following recommendations: a first recommendation to premix about 45 g detergent composition and about 105 mL water in the hollow body member, a second recommendation to apply the premixed detergent composition and water to a fabric by pressing the pump so as to dispense a part of the premix, and a third recommendation to scrub at least a portion of the fabric with the scrubbing surface. The instruction set also recommends that this fabric cleaning process may be used on either fabrics to remove spots and stains to pre-treat them prior to the regular machine laundering process, and as a scrubber on entire fabrics in a hand laundering process.

### EXAMPLE 2

A container is prepared according to Example 1, above, except that the all pieces except the dome and the valve are formed of injected polypropylene. The pump is formed of thermoplastic elastomer bi-injected onto the exterior surface, while the valve is formed of thermoplastic elastomer which is bi-injected onto the scrubbing surface. The hollow body member contains three level indicators for cleaning lightly soiled, normal, and heavily soiled items.

This container is sold with an instruction set as described above, but no detergent composition is included.

### EXAMPLE 3

A container is provided according to FIG. 3, except that the combination of the finger grips and the wrist-palm rest maintain a user's wrist at a use angle of 160°. In addition, there is no brush, and the pump lacks a tab. Instead, the pump is formed of a flexible thermoplastic elastomer which is bi-injection molded to a female screw-cap which affixes to a corresponding male-threaded protrusion which forms the resealable filling orifice. When tightened by hand, the male and female members form a water and air-tight seal. The scrubbing surface is permanently affixed to the hollow body member, and has a single aperture. In fact, only the female screw-cap is intended to be removed from the rest of the container; the rest of the container is formed as a single piece. A thermoplastic elastomer valve is bi-injected with and connected to the single aperture.

An instruction set is provided as described in Example 1, except that the instruction set further includes a recommendation to clean the container by removing the female screw-cap to partially disassemble the container and add it to a washing machine along with clothes to be washed.

### EXAMPLE 4

A container is formed as in FIG. 1 and FIG. 2, except that 10 small apertures, each being about 0.8 mm in diameter, are dispersed around the scrubbing surface. Given the small size of the apertures, no valves are needed, as surface tension holds the mixture of water and detergent composition inside of the hollow body member, unless the pump is depressed.

What is claimed is:

1. A container for applying a detergent composition to a fabric comprising:
A. a hollow body member comprising:
i. an interior surface; and
ii. an exterior surface comprising an ergonomic grip comprising a wrist-palm rest;
B. a scrubbing surface comprising an aperture; and
C. a dispensing passage connecting the interior surface with the aperture.

2. The container according to claim 1, further comprising a resealable filling orifice distinct from the aperture.

3. The container according to claim 1, wherein the wrist-palm rest maintains a user's wrist at a use angle of from about 125° to about 220°.

4. The container of claim 1, wherein the wrist-palm rest contacts the exterior surface at a connection region, the connection region comprising at least one concave surface.

5. The container of claim 1, further comprising a valve connected to the aperture, and wherein during use any materials passing from the interior surface to the scrubbing surface pass through the valve.

6. The container of claim 1, wherein the exterior surface further comprises a pump.

7. The container of claim 6, wherein the pump is distal to the wrist-palm rest.

8. A kit for laundering a fabric comprising the container according to claim 1, and an instruction set, wherein the instruction set comprises:
A. a first recommendation to premix a detergent composition and a solvent in the hollow body member; and
B. a second recommendation to apply the premixed detergent composition and solvent to a fabric.

9. The kit of claim 8, further comprising a detergent composition.

10. The kit of claim 8, further comprising a third recommendation to treat at least a portion of the fabric with the scrubbing surface.

11. A method of laundering a fabric comprising the steps of:
A. providing a container for applying a detergent composition, wherein the container comprises an ergonomic grip comprising a wrist-palm rest;
B. adding a detergent composition to the container;
C. applying the detergent composition to a fabric; and
D. treating at least a portion of the fabric with the container,
wherein during the scrubbing step, the wrist-palm rest maintains a user's wrist at a use angle of from about 125° to about 220°.
